(19) United States
(12) Patent Application Publication
(10) Pub. No.: US 2006/0242331 A1
(43) Pub. Date: Oct. 26, 2006

(54) Information processing apparatus

(75) Inventors: Masayuki Yamada, Kawasaki-shi (JP); Yasuo Okutani, Kawasaki-shi (JP); Satoshi Ookuma, Yokohama-shi (JP); Tsuyoshi Yagisawa, Kawasaki-shi (JP); Kouhei Awaya, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: Canon Kabushiki Kaisha, Ohta-ku (JP)

(21) Appl. No.: 11/404,178

(22) Filed: Apr. 14, 2006

(30) Foreign Application Priority Data
Apr. 22, 2005 (JP) 2005-124978

(51) Int. Cl. G06F 3/00

(52) U.S. Cl. 710/5

(57) ABSTRACT

An information processing apparatus is provided which includes a holding unit configured to hold a setting of the information processing apparatus; a resetting unit configured to reset the setting; a detecting unit configured to detect whether the resetting unit has been operated for a predetermined period of time; and a setting unit configured to set a speech mode when the resetting unit has been operated for the predetermined period of time.

### BACKGROUND OF THE INVENTION

1. Field of the Invention

The present invention relates to a user interface allowing users to operate an apparatus.

2. Description of the Related Art

A speech mode in which speech is used as a user interface has been provided to various kinds of apparatus so as to assist visually impaired users to operate the same. For example, in the speech mode, the following user interfaces are provided to users using speech synthesis. FIG. 4 is an exemplary operation panel for operating an apparatus. A liquid crystal display device 1201, a touch panel 1202, numerical keys, etc. are provided to the operation panel. Virtual keys such as a “paper select” key 1203, “sort” key 1204, and “duplex” key 1205 are implemented on the liquid crystal display device 1201, using a function of the touch panel 1202.

The focus is capable of being set exclusively on each virtual key. In particular, the focus is set on the “duplex” key 1205 (in this specification, the virtual key, on which the focus is set, is indicated by a bold frame).

The functions of “backward focus movement”, “enter”, and “forward focus movement” are assigned to a “4” numerical key 1207, a “5” numerical key 1208, and a “6” numerical key 1209, respectively. Therefore, when the “4” numerical key 1207 is pressed while the focus is set on the “duplex” key 1205, the focus moves to a “sort” key 1204. Similarly, when the “6” numerical key 1209 is pressed, the focus is moved to a “darker” key 1206. When the “5” numerical key 1208 is pressed, the same result occurs as when the key on which the focus has been set is pressed. Accordingly, when the “5” numerical key 1208 is pressed while the focus is set on the “duplex” key 1205, the setting of duplex copying is enabled.

Speech guidance is output whenever a state transition occurs within the apparatus. For example, when the focus is moved to the “sort” key 1204, the speech output of “sort setting” is produced. As an example of providing a speech explanation about the function to be selected, see, for example, Japanese Patent Laid-Open No. 2004-94057.

As described above, users can perform operations in the order of processes, “focus movement”, “speech confirmation”, and “enter”. Accordingly, users can perform almost all operations without depending on their visual senses.

In addition, for example, when a user speaks a command “paper select” while the focus is set on the “duplex” key 1205, the focus can be set on a “paper select” key 1203 at once using speech recognition. Alternatively, when a user speaks a command “B5”, a value (a paper size in this case) can be specified (when the user does not use the speech recognition, the user needs to select the “paper select” key and then select a “B5” key). A method of speech recognition called push-to-talk may be adopted as a user interface. In this method, a user presses a button once before speaking a command, thereby improving the accuracy of the speech recognition. Here, for example, the push-to-talk function may be assigned to a “9” numerical key in the speech mode.

On the other hand, in the mode other than the speech mode (nonspeech mode), each numerical key is used for inputting a corresponding number. For example, when the “4” numerical key 1207 is pressed in the state of FIG. 4, the number of copies is set to four.

In the above-described related art, when an apparatus is shared by users using the speech mode and users using the nonspeech mode, confusion undesirably occurs. This is markedly so in a case where the users using the speech mode are visually impaired people.

For illustrative purposes, an exemplary scenario is provided. Here, it is assumed that a user uses the apparatus in the nonspeech mode after setting the number of copies to 10 and an enlargement ratio to 130%. This setting information is displayed on the liquid crystal display device 1201. When a visually impaired user subsequently uses the same apparatus, confusion is prone to occur. Since the settings of the number of copies and the enlargement ratio that had been set by the previous user remain, the visually impaired user experiences an unintended consequence when performing the operation. This occurs because the visually impaired user cannot recognize setting information displayed on the liquid crystal display device 1201. If a function of speech output related to a current setting is implemented, this problem will be supposedly solved.

However, it is time consuming to recognize a setting using the speech output with each transition to the speech mode. In addition, this can causes human error.

Accordingly, the present invention provides an information processing apparatus that contributes to preventing users' confusion in a case where an apparatus is shared by a plurality of users.

### SUMMARY OF THE INVENTION

According to a first exemplary embodiment, an information processing apparatus is provided which includes a holding unit configured to hold a setting of the information processing apparatus; a resetting unit configured to reset the setting; a detecting unit configured to detect whether the resetting unit has been operated for a predetermined period of time; and a setting unit configured to set a speech mode when the resetting unit has been operated for the predetermined period of time.

According to another aspect of the embodiment, the resetting unit is a reset button, the detecting unit detects whether the reset button has been kept pressed for a predetermined period of time, and the setting unit sets the speech mode when the reset button has been kept pressed for the predetermined period of time. According to another aspect of the embodiment, the setting unit terminates the speech mode when the resetting unit has been operated for the predetermined period of time in a case where a mode for visually impaired users is set.

According to another exemplary embodiment of the present invention, an information processing apparatus is provided which includes a holding unit configured to hold a setting of the information processing apparatus; a resetting unit configured to reset the setting; a detecting unit configured to detect whether the resetting unit has been operated a plurality of times within intervals of a predetermined time; and a setting unit configured to set a speech mode when the resetting unit has been operated a plurality of times within the intervals of the predetermined time.

According to another aspect of the embodiment, the resetting unit is a reset button, the detecting unit detects whether the reset button has been pressed a plurality of times, and the setting unit sets the speech mode when the reset button has been pressed a plurality of times. According to yet another aspect of the embodiment, the speech mode uses speech synthesis as a user interface. According to still yet another aspect of the embodiment, the speech mode uses speech recognition as a user interface.

According to another exemplary embodiment of the present invention, an information processing apparatus is provided which includes a holding unit configured to hold a setting of the information processing apparatus; a resetting unit configured to reset the setting; a detecting unit configured to detect whether the resetting unit has been operated for a predetermined period of time; and a setting unit configured to set a mode for visually impaired users when the resetting unit has been operated for the predetermined period of time.

Furthermore, according to yet another exemplary embodiment of the present invention, an information processing apparatus is provided which includes a holding unit configured to hold a setting of the information processing apparatus; a resetting unit configured to reset the setting; a detecting unit configured to detect whether the resetting unit has been operated a plurality of times within intervals of a predetermined time; and a setting unit configured to set a mode for visually impaired users when the resetting unit has been operated a plurality of times within the intervals of the predetermined time.

Moreover, according to another aspect of the embodiment, the mode for visually impaired users uses speech synthesis as a user interface. Further, according to another aspect of the embodiment, the mode for visually impaired users uses speech recognition as a user interface.

Additionally, according to another exemplary embodiment of the present invention, an information processing method to be performed in an information processing apparatus that has a holding unit for holding a setting of the information processing apparatus is provided. The information processing method includes a resetting step of resetting the setting using a resetting unit; a detecting step of detecting whether the resetting unit has been operated for a predetermined period of time in the resetting step; and a setting step of setting a speech mode when the resetting unit is detected to have been operated for the predetermined period of time in the detecting step.

Furthermore, according to yet another exemplary embodiment of the present invention, an information processing method to be performed in an information processing apparatus that has a holding unit for holding a setting of the information apparatus. The information processing method includes a resetting step of resetting the setting using a resetting unit; a detecting step of detecting whether the resetting unit has been operated a plurality of times within intervals of a predetermined time in the resetting step; a setting step of setting a speech mode when the resetting unit is detected to have been operated a plurality of times within the intervals of the predetermined time in the detecting step.

According to another exemplary embodiment of the present invention, an information processing method to be performed in an information processing apparatus that has a holding unit for holding a setting of the information processing apparatus is provided. The information processing method includes a resetting step of resetting the setting using a resetting unit; a detecting step of detecting whether the resetting unit has been operated for a predetermined period of time in the resetting step; and a setting step of setting a mode for visually impaired users when the resetting unit is detected to have been operated for the predetermined period of time in the detecting step.

And, according to still yet another exemplary embodiment, an information processing method to be performed in an information processing apparatus that has a holding unit for holding a setting of the information processing apparatus is provided. The information processing method includes a resetting step of resetting the setting using a resetting unit; a detecting step of detecting whether the resetting unit has been operated a plurality of times within intervals of a predetermined time in the resetting step; and a setting step of setting a mode for visually impaired users when the resetting unit is detected to have been operated a plurality of times within the intervals of the predetermined time in the detecting step.

Further features of the present invention will become apparent from the following description of exemplary embodiments with reference to the attached drawings.

### BRIEF DESCRIPTION OF THE DRAWINGS

FIG. 1 is a block diagram showing a hardware configuration according to a first exemplary embodiment of the present invention.

FIG. 2 is a flowchart showing an exemplary process flow according to a first embodiment of the present invention.

FIG. 3 is a flowchart showing an exemplary process flow according to a second embodiment of the present invention.

FIG. 4 is a diagram illustrating an image of an operation panel according to embodiments and the background art of the present invention.

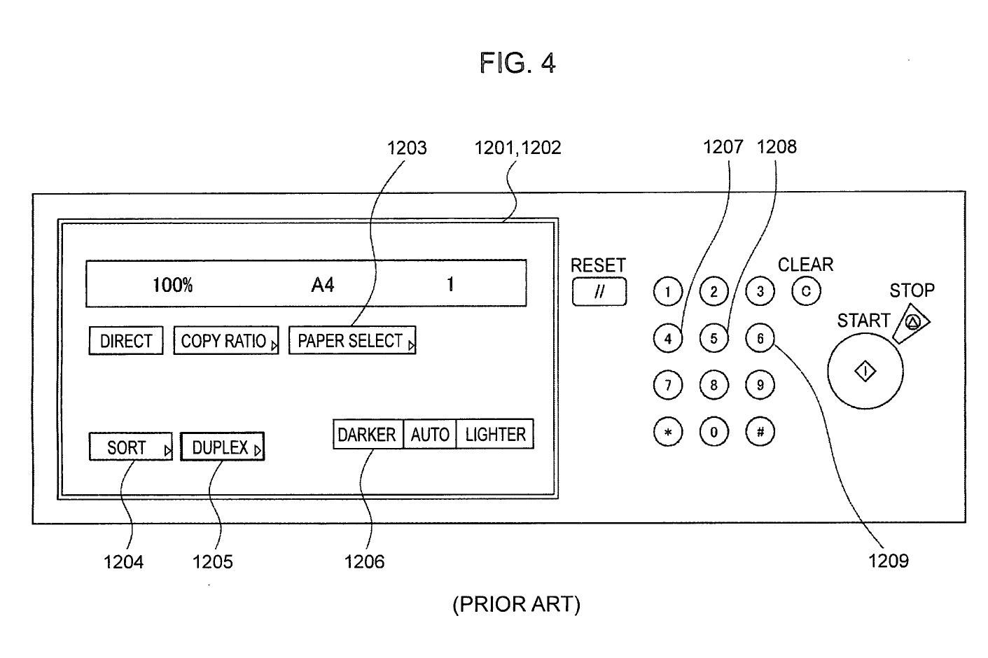

### DESCRIPTION OF THE EMBODIMENTS

Numerous embodiments, features and aspects of the present invention will now be described with reference to the accompanying drawings.

### First Exemplary Embodiment

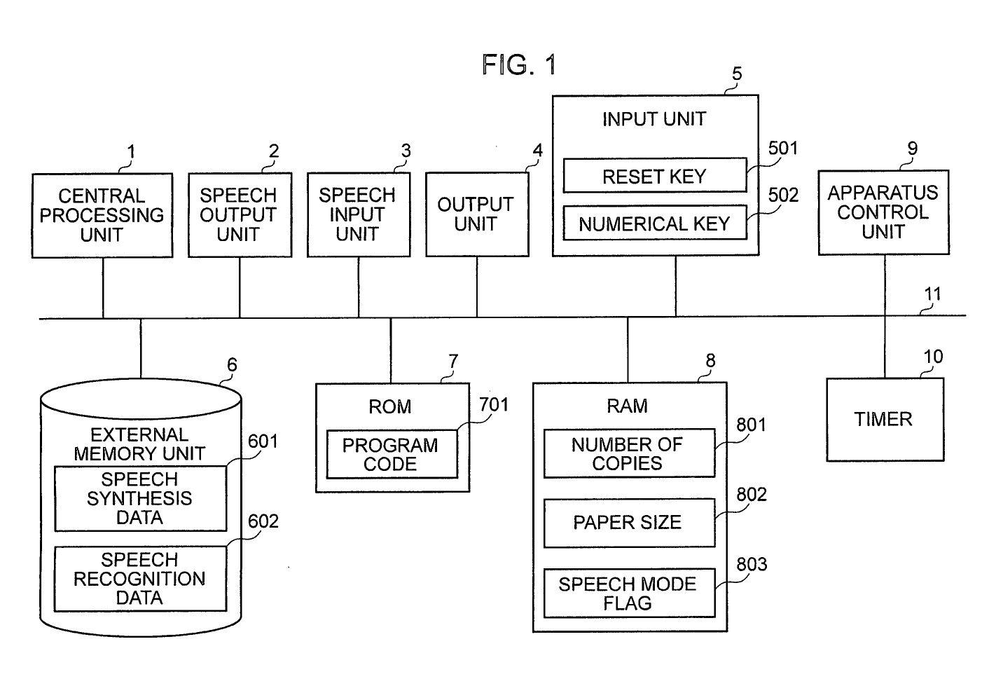

FIG. 1 is an exemplary hardware configuration according to a first embodiment of the present invention. A central processing unit 1 intended for performing math processing, control operation, etc. performs the operations in accordance with a procedure to be described in this embodiment. A speech output unit 2 is intended for providing speech to users. A speech input unit 3 is intended for inputting users' voices therein. An output unit 4 is intended for providing information to users. As a typical example of the output unit, an image output device such as a liquid crystal display device can be considered. However, the output unit 4 and the speech output unit 2 may be a common unit. Alternatively, the output unit 4 may be a simple unit only intended for lamp flashing.

An input unit 5 such as a touch panel, a keyboard, a mouse, or a button is used for users to give operation instructions to this apparatus. The input unit 5 includes a reset key 501, a numerical key 502, etc.

An external memory unit 6 such as a disk drive or a nonvolatile memory holds speech synthesis data 601 used for speech synthesis and speech recognition data 602 used for speech recognition. In addition, the external memory unit 6 holds information that should be permanently used among various information held in a RAM 8. The external memory unit 6 may be a portable type of unit such as a CD-ROM or a memory card, thereby enhancing its convenience. A read only memory 7 stores a program code 701 for realizing the present invention and fixed data (not shown). In the present invention, users can arbitrarily use the external memory unit 6 or the ROM 7. For example, the program code 701 may be installed in the external memory unit 6 instead of the ROM 7.

A memory unit 8 such as RAM holds temporary information that includes not only the number of copies 801, a paper size 802, and other set values but also temporary data and various kinds of flags such as a speech mode flag 803.

An apparatus control unit 9 controls a scanner, a printer, etc. that are attached to this apparatus. A timer 10 performs time of day control, and is used to measure elapsed time and generate an event after a predetermined period of time. Units from the central processing unit 1 through to the timer 10 are connected each other by a bus 11.

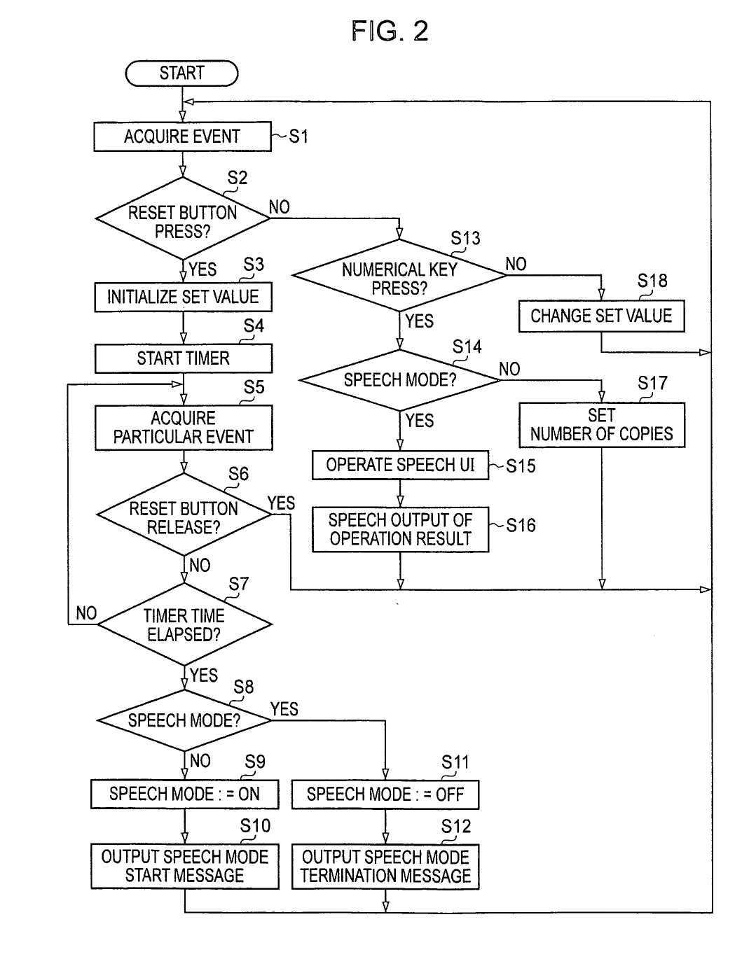

Next, an exemplary process flow according to this embodiment will be described with reference to FIG. 2. In this embodiment, event-driven processing may be employed. However, this is nonessential, thus the subject matter of the present invention can also be realized in accordance with poling, etc. Firstly, in step S1, a new event is acquired. If no event has been generated, the process is locked until an event is generated. In this embodiment, a user inputs a type of event by pressing a button. However, an event generated within the apparatus such as speech output termination may be included in this embodiment.

Subsequently, in step S2, it is determined whether the event acquired in steps 1 is a “reset button press” event. As a result of the determination, if the event acquired in step S1 is the “reset button press” event, the process proceeds to step S3. If the event is not the “reset button press” event, the process proceeds to step S13. In step S3, set values such as the number of copies and a paper size are reset to default values. Then, in step S4, a timer is set so as to generate a “timer time elapsed” event after a predetermined period of time has elapsed, and is then started. Subsequently, in step S5, a new event is acquired. In this step, all types of event may not be received, but the event to be acquired may be limited to a particular event.

Then, in step S6, it is determined whether the event acquired in step S5 is a “reset button release” event. If the event is the “reset button release” event, the process returns to step S1. If the event is not the “reset button release, event, the process proceeds to step S7. In step S7, it is determined whether the event acquired in step S5 is a “timer time elapsed” event. If the event is the “timer time elapsed” event, the process proceeds to step S8. If the event is not the “timer time elapsed” event, the process returns to step S5. In step S8, it is determined whether a current mode is the speech mode. If the current mode is the speech mode, the process proceeds to step S11. If the current mode is not the speech mode, the process proceeds to step S9.

In step S9, the speech mode is set. That is, the speech mode flag 803 is set to “on”. Subsequently, in step S10, a message informing the user that the speech mode has been set is output. For example, a message such as “speech mode has been started” is output from the speech output unit 2. After step S10, the process returns to step S1. In step S11, the speech mode is reset to the original mode. That is, the speech mode flag 803 is set to “off”. Next, in step S12, a message informing the user that the speech mode has been terminated is output.

For example, a message such as “speech mode has been terminated” is output from the speech output unit 2. After step S12, the process returns to step S1. If the reset button is not pressed in step S2, then in step S13, it is determined whether the event acquired in step S1 is a “numerical key press” event. If the event is the “numerical key press” event, the process proceeds to step S14. If the event is not the “numerical key press” event, the process proceeds to step S18.

In step S14, it is determined whether a current mode is the speech mode. If the current mode is the speech mode, the process proceeds to step S15. If the current mode is not the speech mode, the process proceeds to step S17. In step S15, UI operation corresponding to a pressed numerical key is performed. For example, if the pressed numerical key is a “4” key, a focus moves backward. If the pressed numerical key is a “6” key, the focus moves forward. If the pressed numerical key is a “5” key, processing similar to that performed when a focused button is pressed is performed.

Subsequently, in step S16, speech output informing the user of the result of step S15 is produced. For example, if the focus moves to a “duplex” button as a result of focus movement, speech output such as “duplex copying setting” is produced. After step S16, the process returns to step S1.

In step S17, a set value of the number of copies is changed in accordance with a pressed numerical key, and then the process returns to step S1. In step S18, a set value is changed in accordance with the event acquired in step S1, and then the process returns to step S1. In the case of an interface that uses speech recognition, since the result of the speech recognition is construed as an event, the processing of the result of speech recognition is also performed in this step.

According to the above-described configuration, the setting of the speech mode is certainly performed along with the resetting of the setting of the information processing apparatus. In other words, the setting of the information processing apparatus is certainly reset immediately after the speech mode has been set, thereby not confusing users even if a plurality of users share the apparatus.

### Second Exemplary Embodiment

Next, a second exemplary embodiment of the present invention according to double-clicking on a reset button will be described. Here, the hardware configuration of this embodiment is similar to that of the first embodiment, and therefore, only the differences in the second embodiment will be discussed.

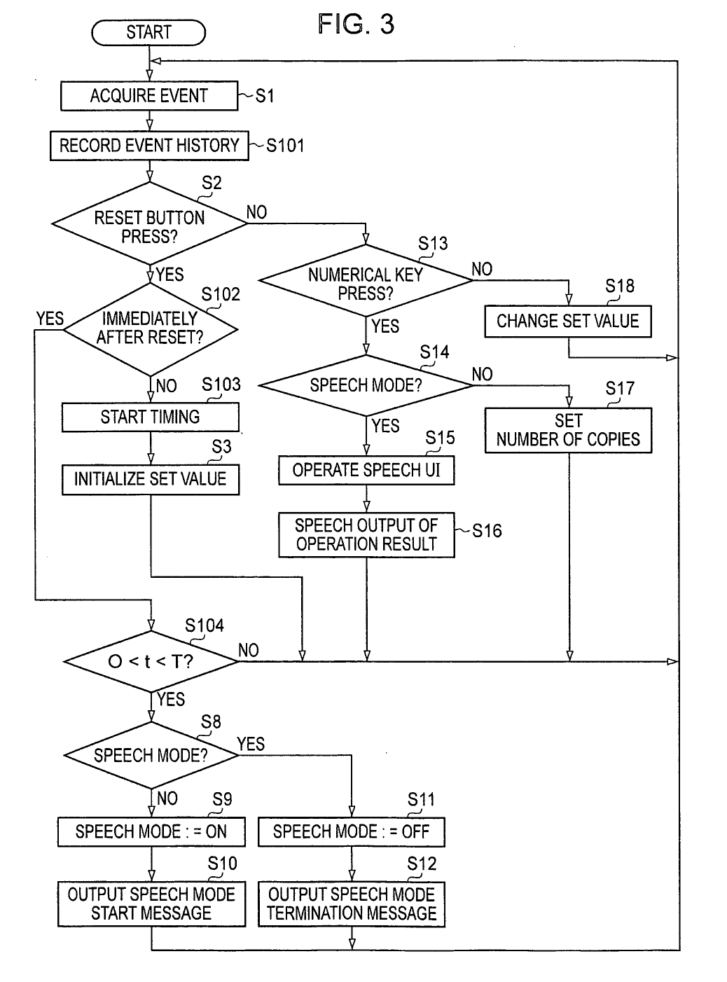

An exemplary process flow according to the second embodiment will be described with reference to FIG. 3. Here, the steps of the process shown in FIG. 3 that are similar to those of the first embodiment have the same reference numbers. First, in step S1, a new event is acquired. If no event is acquired, the process is locked until an event is generated. Next, in step S101, the event acquired in step S1 is recorded.

Subsequently, in step S2, it is determined whether the event acquired in step S1 is a “reset button press” event. As a result of the determination, if the event acquired in step S1 is the “reset button press” event, the process proceeds to step S102. If the event acquired in step S1 is not the “reset button press” event, the process proceeds to step S13.

In step S102, it is determined whether the reset button is pressed again subsequent to the immediately preceding pressing of the reset button on the basis of the history recorded in step S101. As a result of a determination, in the case of the reset button being pressed again immediately after the previous pressing of the reset button, the process proceeds to step S104. In the case of the reset button not being pressed again immediately after the pressing of the reset button, the process proceeds to step S103.

In step S103, after a timer value is set to zero, timing is started. In contrast to the first embodiment, in this embodiment, an event that is generated by the timer is not generated. After step S103, the set value is reset to a default value (step S3), and then the process returns to step S1.

In step S104, on the basis of the timing information according to the timer, it is determined whether an elapsed time since the immediately preceding pressing of the reset button is less than a threshold value (T). As a result of the determination, if the elapsed time since the immediately preceding pressing of the reset button is less than the threshold value T, the process proceeds to step S8. If the elapsed time since the immediately preceding pressing of the reset button is not less than the threshold value T, the process returns to step S1. Processes of other steps are identical to those of the first embodiment.

According to the above-described configuration, the setting of the speech mode is certainly performed along with the resetting of the setting of the apparatus, thereby not confusing users even if a plurality of users share the apparatus.

### Other Exemplary Embodiments

In each of above-described embodiments, a subject to be reset has been described as a set value such as a paper size or the number of copies. However, the subject to be reset may include an internal state of the apparatus such as the number of copies that have been produced or a progress of processing.

In each of the above-described embodiments, the pressing or releasing of the reset button is arbitrarily used. For example, in the description of the first embodiment, the set value is reset to the default value when the reset button is pressed. However, the set value may be reset to the default value when the reset button is released.

In addition, details to be reset may change in accordance with the time between when the reset button is pressed and when the reset button is released. For example, if the time of the pressing of the reset button is less than a threshold value, all set values may be reset. If the time is more than the threshold value, settings other than a duplex copying setting may be reset. In this case, when the former or latter resetting is performed, speech informing the user that the former or latter resetting has been performed may be output. For example, when the former resetting is performed, speech output such as “first stage resetting has been performed” is produced. When the latter resetting is performed, speech output such as “the second stage resetting has been performed” is produced. According to this configuration, users can easily know the situation of the resetting operation.

Various types of speech synthesis method such as a synthesis-by-rule method and a recording and editing synthesis method exist. Various types of speech recognition method such as a word recognition method, a continuous recognition method, a speaker-dependent recognition method, and a speaker-independent recognition method exist. The present invention is effective regardless of which of these speech synthesis and speech recognition methods is used.

Furthermore, in a mode for visually impaired users, a Braille input and output device is considered to be jointly used. Users other than visually impaired users cannot read information that is output to the Braille output device. Accordingly, the present invention is also effective in this case.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2005-124978 filed Apr. 22, 2005, which is hereby incorporated by reference herein in its entirety.

What is claimed is:

1. An information processing apparatus comprising:
a holding unit configured to hold a setting of the information processing apparatus;
a resetting unit configured to reset the setting;
a detecting unit configured to detect whether the resetting unit has been operated for a predetermined period of time; and
a setting unit configured to set a speech mode when the resetting unit has been operated for the predetermined period of time.

2. The information processing apparatus according to claim 1,
wherein the resetting unit is a reset button,
wherein the detecting unit detects whether the reset button has been kept pressed for a predetermined period of time, and
wherein the setting unit sets the speech mode when the reset button has been kept pressed for the predetermined period of time.

3. The information processing apparatus according to claim 1,
wherein the setting unit terminates the speech mode when the resetting unit has been operated for the predetermined period of time in a case where a mode for visually impaired users is set.

4. An information processing apparatus comprising:
a holding unit configured to hold a setting of the information processing apparatus;
a resetting unit configured to reset the setting;
a detecting unit configured to detect whether the resetting unit has been operated a plurality of times within intervals of a predetermined time; and
a setting unit configured to set a speech mode when the resetting unit has been operated a plurality of times within the intervals of the predetermined time.

5. The information processing apparatus according to claim 4,
wherein the resetting unit is a reset button,
wherein the detecting unit detects whether the reset button has been pressed a plurality of times, and
wherein the setting unit sets the speech mode when the reset button has been pressed a plurality of times.

6. The information processing apparatus according to claim 1,
wherein the speech mode uses speech synthesis as a user interface.

7. The information processing apparatus according to claim 1,
wherein the speech mode uses speech recognition as a user interface.

8. An information processing apparatus comprising:
a holding unit configured to hold a setting of the information processing apparatus;
a resetting unit configured to reset the setting;
a detecting unit configured to detect whether the resetting unit has been operated for a predetermined period of time; and
a setting unit configured to set a mode for visually impaired users when the resetting unit has been operated for the predetermined period of time.

9. An information processing apparatus comprising:
a holding unit configured to hold a setting of the information processing apparatus;
a resetting unit configured to reset the setting;
a detecting unit configured to detect whether the resetting unit has been operated a plurality of times within intervals of a predetermined time; and
a setting unit configured to set a mode for visually impaired users when the resetting unit has been operated a plurality of times within the intervals of the predetermined time.

10. The information processing apparatus according to claim 8,
wherein the mode for visually impaired users uses speech synthesis as a user interface.

11. The information processing apparatus according to claim 8,
wherein the mode for visually impaired users uses speech recognition as a user interface.

12. An information processing method to be performed in an information processing apparatus that has a holding unit for holding a setting of the information processing apparatus, the information processing method comprising:
a resetting step of resetting the setting using a resetting unit;
a detecting step of detecting whether the resetting unit has been operated for a predetermined period of time in the resetting step; and
a setting step of setting a speech mode when the resetting unit is detected to have been operated for the predetermined period of time in the detecting step.

13. An information processing method to be performed in an information processing apparatus that has a holding unit for holding a setting of the information apparatus, the information processing method comprising:
a resetting step of resetting the setting using a resetting unit;
a detecting step of detecting whether the resetting unit has been operated a plurality of times within intervals of a predetermined time in the resetting step;
a setting step of setting a speech mode when the resetting unit is detected to have been operated a plurality of times within the intervals of the predetermined time in the detecting step.

14. An information processing method to be performed in an information processing apparatus that has a holding unit for holding a setting of the information processing apparatus, the information processing method comprising:
a resetting step of resetting the setting using a resetting unit;
a detecting step of detecting whether the resetting unit has been operated for a predetermined period of time in the resetting step; and
a setting step of setting a mode for visually impaired users when the resetting unit is detected to have been operated for the predetermined period of time in the detecting step.

15. An information processing method to be performed in an information processing apparatus that has a holding unit for holding a setting of the information processing apparatus, the information processing method comprising:
a resetting step of resetting the setting using a resetting unit;
a detecting step of detecting whether the resetting unit has been operated a plurality of times within intervals of a predetermined time in the resetting step; and
a setting step of setting a mode for visually impaired users when the resetting unit is detected to have been operated a plurality of times within the intervals of the predetermined time in the detecting step.
